(19) United States
(12) Patent Application Publication
(10) Pub. No.: US 2005/0253793 A1
(43) Pub. Date: Nov. 17, 2005

(54) DRIVING METHOD FOR A LIQUID CRYSTAL DISPLAY

(76) Inventors: Liang-Chen Chien, Chia-Yi Hsien (TW); Yuh-Ren Shen, Tai-Nan City (TW); Cheng-Jung Chen, Miao- Li Hsien (TW); Yung-Hung Shen, Hsin-Chu City (TW); Yi-Fan Chen, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 10/709,506

(22) Filed: May 11, 2004

(51) Int. Cl. G09G 3/36

(52) U.S. Cl. 345/87

(57) ABSTRACT

A method for driving a liquid crystal display panel is disclosed. The liquid crystal display panel has a plurality of scan lines, a plurality of data lines, and a plurality of pixels. Each pixel is connected to a corresponding scan line and a corresponding data line, and each pixel has a liquid crystal element and a switching device connected to the corresponding scan line, the corresponding data line, and the liquid crystal element. The method sequentially receives a plurality of pieces of frame data and generates at least one over-drive data impulse and an original data impulse for each pixel every frame period according to the pieces of the frame data. The over-drive data impulse and the original data impulse are applied to the data line connected to the liquid crystal element of the pixel within one frame period.

### BACKGROUND OF INVENTION

1. Field of the Invention

The invention relates to a driving method of a liquid crystal display, and more particularly, to a driving method that sequentially supplies an over-drive data voltage pulse and an original data voltage pulse to a pixel electrode in one frame period.

2. Description of the Prior Art

A liquid crystal display (LCD) has advantages of lightweight, low power consumption, and low divergence, and is applied to various portable equipment, such as notebook computers and personal digital assistants (PDA). In addition, LCD monitors and LCD televisions are gaining in popularity as a substitute for traditional cathode ray tube (CRT) monitors and televisions. However, an LCD still has some disadvantages. Because of the limitations of physical characteristics, the liquid crystal molecules should be twisted and rearranged when changing input data, delaying the images. For satisfying the rapid switching requirements of multimedia equipment, improving the response speed of liquid crystal is desired.

When driving the liquid crystal display, the driving circuit continuously receives a plurality of frame data, and produces the related data voltage pulse, scan voltage, clock signal, and so on in accordance with the frame data to control the pixel operation of the liquid crystal display. Each frame data includes the data for refreshing all pixels in one frame period, so each frame data can be treated as having a plurality of pixel data, and each pixel data is used for defining the gray level status of one pixel in one frame period. Illuminating with the liquid crystal display standard of general computers, each pixel can be switched between 256 (2⁸) gray levels, and the data length of each pixel data is 8 bits.

Please refer to FIG. 1, which is a timing diagram of the pixel data value and the frame period according to the prior art. When driving a pixel, the driving circuit sequentially receives a plurality of pixel data for driving the pixel. As shown in FIG. 1, G(n), G(n+1), and G(n+2) are the pixel data received by the driving circuit in the frame period N, N+1 and N+2. The driving circuit will drive the gray level status of one pixel in the frame period N, N+1 and N+2 in accordance with the pixel data values recorded in the pixel data G(n), G(n+1), and G(n+2). Generally speaking, after being driven by the driving circuit, larger the pixel data value, higher the gray level value. Then, the driving circuit will produce a original data voltage pulse in the corresponding frame period according to the pixel data G(n), G(n+1), and G(n+2), and apply the original data voltage pulse to the pixel electrode of the corresponding pixel to drive the pixel showing the corresponding gray level status in each frame period.

Please refer to FIG. 2, which is a timing diagram of the transmission rate and the frame period according to the prior art. In FIG. 2, curve C1 shows the transmission rate under the ideal condition, and curve C2 shows the transmission rate driven by a conventional over-drive method. Both C1 and C2 are driven from the transmission rate T1 to T2 in the frame period N. The conventional over-drive method is disclosed in the U.S. Publication 2002/0050965, and is simply described below. Because of the characteristics of the liquid crystal molecules, a delay time appears while charging and the liquid crystal molecule cannot reach the expected transmission rate with an expected angle in one frame period. Without an over-drive method, the expected transmission rate cannot be reached in the frame period N and have a great difference with the ideal condition. This delay will induce a blurred appearance.

For improving this condition, a conventional over-drive method is used in some liquid crystal displays that apply a higher or lower data voltage pulse to the pixel electrode to accelerate the response speed of the liquid crystal molecule. For accelerating the response speed of the liquid crystal molecules as fast as possible, as shown in FIG. 2, a much higher over-drive data voltage pulse is used to shorten the switching time, but also results in the transmission rate being too high or too low. As shown in FIG. 2, with the conventional over-drive method, the liquid crystal molecules reach the transmission rate of the expected gray level status T2 in one frame period, but the final transmission rate reaches a higher value T3. This conventional over-drive method may cause the reality loss and the gray level status may be too bright or too dark.

### SUMMARY OF INVENTION

It is therefore a primary objective of the claimed invention to provide a driving method of a liquid crystal display panel that can accelerate the response speed of the liquid crystal molecules and enable the liquid crystal display panel to reach the expected transmission rate in one frame period.

According to the claimed invention, a method for driving a liquid crystal display panel is disclosed. The liquid crystal display panel includes a plurality of scan lines, a plurality of data lines, and a plurality of pixels. Each pixel is connected to a corresponding scan line and a corresponding data line, and each pixel has a switching device and a liquid crystal element. The switching device is connected to the corresponding scan line, the corresponding data line, and the liquid crystal element. The method includes continuously receiving a plurality of frame data and, producing an over-drive data voltage pulse and an original data voltage pulse according to the frame data in every frame period. The over-drive data voltage pulse and the original data voltage pulse are sequentially provided to the liquid crystal element of the pixel in one frame period via the connected data line.

According to the claimed invention, a method for driving a liquid crystal display panel is further disclosed. The liquid crystal display panel includes a plurality of scan lines, a plurality of data lines, and a plurality of pixels. Each pixel is connected to a corresponding scan line and a corresponding data line, and each pixel has a switching device and a liquid crystal element. The switching device is connected to the corresponding scan line, the corresponding data line, and the liquid crystal element. The method includes receiving a clock signal, a synchronization signal, and a plurality of frame data. A double-frequency clock signal is produced in accordance with the clock signal, and a double-frequency synchronization signal is produced in accordance with the double-frequency clock signal and the synchronization signal. At least an over-drive data voltage pulse and a original data voltage pulse are produced in accordance with the frame data. The over-drive data voltage pulse and the original data voltage pulse are sequentially provided to the liquid crystal element of the corresponding pixel in accordance with the double-frequency clock signal in one frame period.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a timing diagram of pixel data values and frame periods according to the prior art.

FIG. 2 is a timing diagram of transmission rates and frame periods according to the prior art.

FIG. 3 is a schematic diagram of a liquid crystal display panel.

FIG. 4 is a schematic diagram of processing a frame data according to the present invention.

FIG. 5 is a timing diagram of pixel data values and frame periods before utilizing the present invention.

FIG. 6 is a timing diagram of pixel data values and frame periods after utilizing the present invention.

FIG. 7 and FIG. 8 are timing diagrams of transmission rates and frame periods according to the present invention.

FIG. 9 is a block diagram of a preferred circuit to achieve the present invention.

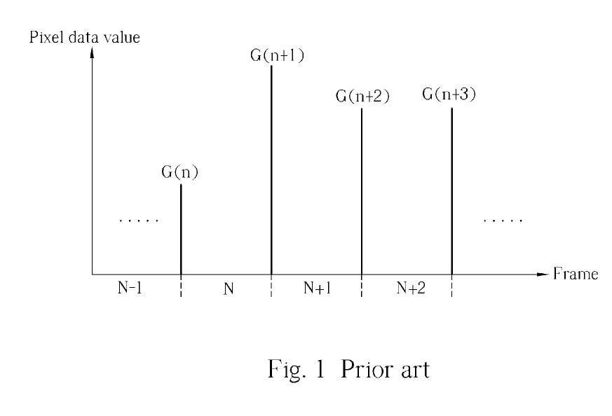

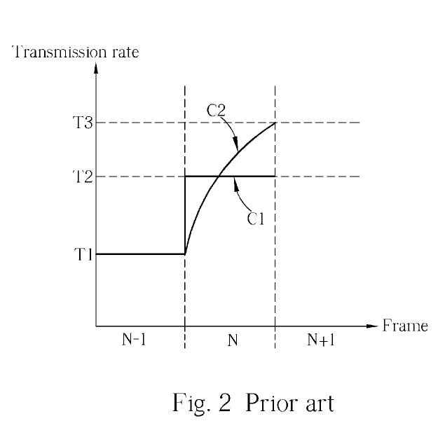

### DETAILED DESCRIPTION

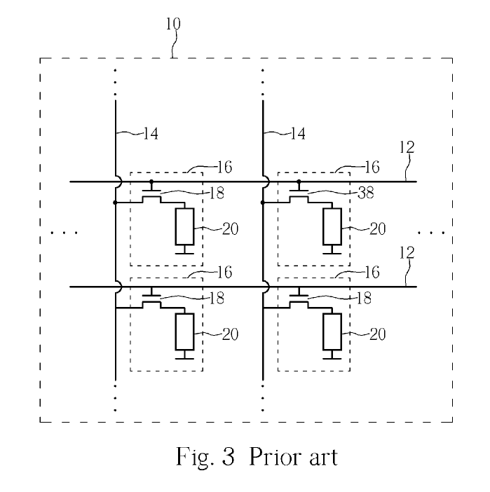

Please refer to FIG. 3, which is a schematic diagram of a liquid crystal display panel 10. The liquid crystal display panel 10 includes a plurality of scan lines 12, a plurality of data lines 14, and a plurality of pixels 16. Each pixel 16 is connected to a corresponding scan line 12 and a corresponding data line 14, and each pixel 16 has a switching device 18 and a liquid crystal element 20. The liquid crystal element 20 is generally called a pixel electrode. The switching device 18 is connected to the corresponding scan line 12 and the corresponding data line 14, and the driving circuit will control operation of each pixel 16 via the scan line 12 and the data line 14.

The general method for driving the liquid crystal display panel 10 is to apply a scan voltage to the scan line 12 to open the switching device 18 and to apply a data voltage to the data line 14 to control the pixel electrode 20 through the switching device 18. Hence, when the scan voltage is applied to the scan line 12 and the switching device 18 is opened, the data voltage pulse on the data line 14 will be applied to the pixel electrode 20 through the switching device 18 to twist the liquid crystal molecule. When the scan voltage on the scan line 12 is removed and the switching device 18 is closed, the electrical connection of the data line 14 and the pixel 16 will be cut and the pixel electrode 20 will retain the charged status. The scan line 12 controls the switching device 18 to repeatedly open and close, repeatedly charging the pixel electrode 20 utilizing the data line 14. Different data voltages on the data line 14 produce different twisted angles of the liquid crystal molecules and show different transmission rates. With this repeated operation, the liquid crystal display 10 can show different images.

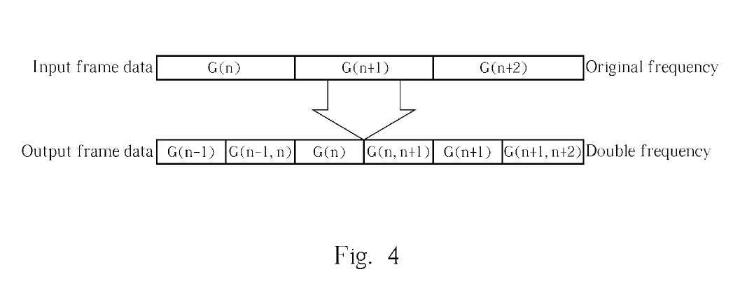

Please refer to FIG. 4, which is a schematic diagram of processing a frame data according to the present invention. This embodiment uses a double frequency example to explain the present invention, but the driving method is not limited to using a double frequency and a higher frequency can be used without departing from the spirit of the invention. When the pixel data value is switched from G(N) to G(n+1), the present method delays the frame data G(n), G(n+1), and G(n+2) while receiving them, and produces the corresponding delayed frame data. The present pixel data value G(n+1) is compared with the corresponding delayed pixel data value G(n) and an over-drive data value G(n,n+1) is produced. The over-drive data value G(n,n+1) is defined according to the difference between the pixel data values G(n) and G(n+1), and can be larger, smaller or equal to G(n+1). Generally, when G(n+1) is larger than G(n), G(n,n+1) will be larger than G(n+1); when G(n+1) is smaller than G(n), G(n,n+1) will be smaller than G(n+1); and when G(n+1) is equal to G(n), G(n,n+1) will be also equal to G(n+1). In addition, the other over-drive data values G(n−1,n), G(n+1,n+2) . . . corresponding to other clock periods can be also be produced by the above-mentioned method.

After producing the over-drive data values G(n−1,n), G(n+1,n+2) . . . , the present method outputs the over-drive data voltage pulses corresponding to the over-drive data values (such as G(n−1,n), G(n+1,n+2) . . . ) to the pixels on the liquid crystal display panel via the related scan line and data line driving circuits, and then the original data voltage pulses corresponding to the original pixel data (such as G(n), G(n+1), G(n+2) . . . ) are outputted to the pixels on the liquid crystal display panel. The action of outputting the over-drive data voltage pulse and the original data voltage pulse must be completed in one frame period. Since two data voltage pulses (the over-drive data voltage pulse and the original data voltage pulse) are outputted in one frame period, the frame data outputting frequency is double of the conventional driving method.

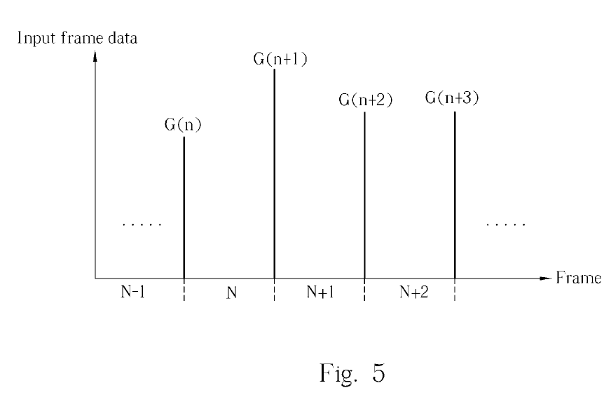

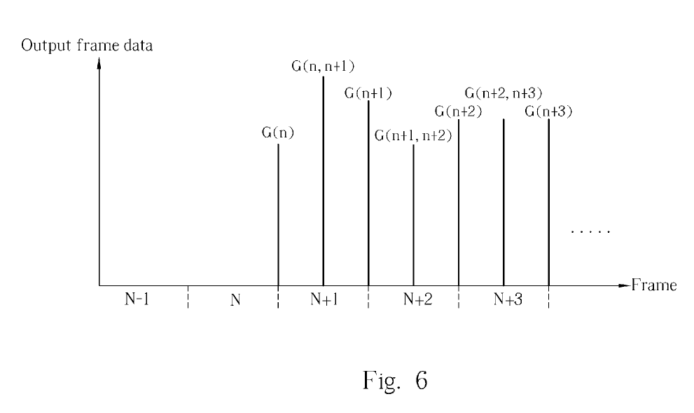

Please refer to FIGS. 5 and 6, which are timing diagrams of pixel data value and frame period before and after utilizing the present invention. When the input pixel data value switches from G(n) to G(n+1), G(n+2), and G(n+3), the output pixel data value after utilizing the present invention will be G(n,n+1), G(n+1), G(n+1,n+2), G(n+2), G(n+2,n+3) and G(n+3). G(n,n+1), G(n+1,n+2) and G(n+2,n+3) are over-drive data values that can accelerate the switching speed of the liquid crystal molecule. Besides instantly comparing the delayed and original frame data to produce the over-drive data value, for accelerating the processing speed, a reference table can be also pre-built by measuring every frame data and its preferred over-drive data value in advance. When switching the frame data, a corresponding over-drive data value will be caught from the reference table to drive the pixel electrode.

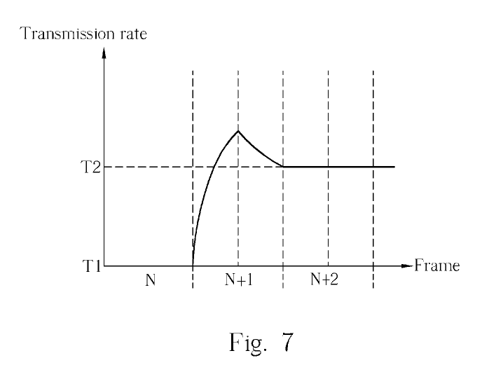

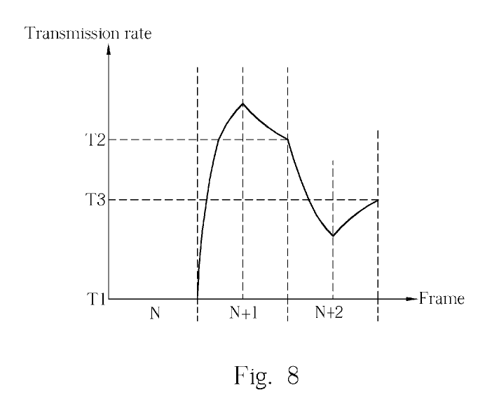

Please refer to FIGS. 7 and 8, which are timing diagrams of transmission rates and frame periods according to the present invention. In FIG. 7, the liquid crystal molecules are switched from the transmission rate T1 to a higher transmission rate T2, and are kept at T2. A larger over-drive data value G(n,n+1) is used to switch the liquid crystal molecule to a transmission rate higher than T2, and then the original data value G(n+1) switches the liquid crystal molecule to the transmission rate T2.

FIG. 8 shows another situation of switching the liquid crystal molecules from the transmission rate T1 to a higher T2, and then switches to a transmission rate T3 lower than T2 in next frame period. In the frame period N+1, a larger over-drive data value G(n,n+1) is used to switch the liquid crystal molecule to a transmission rate higher than T2, and the original data value G(n+1) switches the liquid crystal molecule to the transmission rate T2. In the frame period N+2, a smaller over-drive data value G(n+1,n+2) is used to switch the liquid crystal molecule from the transmission rate T2 to a transmission rate lower than T3, and the original data value G(n+2) switches the liquid crystal molecule to the transmission rate T3.

With sequentially applying the over-drive data values and the original data values to the liquid crystal display panel, the switching speed of the liquid crystal molecule can be accelerated and the transmission rate can be also accurately controlled. When watching the rapidly switched liquid crystal display, users will no longer feel a delay, reality loss, or brightness reduction.

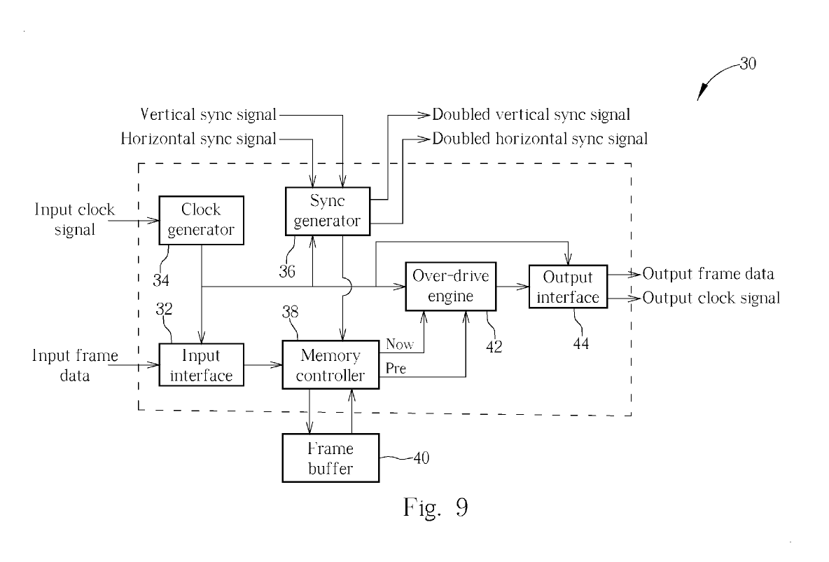

Please refer to FIG. 9, which is a block diagram of a preferred circuit 30 to achieve the present invention. An input interface 32 continuously receives the input frame data, a clock generator 34 receives an input clock signal, and a sync generator 36 receives a vertical sync signal and a horizontal sync signal. The clock generator 34 doubles frequency of the input clock signal, and outputs the doubled clock signals to the input interface 32, the sync generator 36, an over-drive engine 42, and an output interface 44. After receiving the doubled clock signal, the sync generator 36 will double frequency of the vertical and horizontal sync signals and output the doubled vertical and horizontal sync signals to drive the scan and data lines of the liquid crystal display panel. After receiving the input frame data, the input interface 32 will transmit the input frame data to a memory controller 38 for processing. On the one hand, the memory controller 38 stores and accesses the input frame data in a frame memory 40 to delay the input frame data and produce a delayed frame data PRE. On the other hand, the memory controller 38 also outputs a present frame data NOW and transmits the present frame data NOW and the corresponding delayed frame data PRE to the over-drive engine 42. The over-drive engine 42 catches an over-drive data value from a pre-built reference table in accordance with the present frame data NOW and the corresponding delayed frame data PRE, and sequentially outputs the over-drive data value and the original data value to an output interface 44 in accordance with the doubled clock signal. With the doubled frequency, the output interface 44 sequentially outputs the over-drive data value and the original data value to the scan line and data line driving circuits on the liquid crystal display panel for producing the over-drive data voltage pulse and the original data voltage pulse to the liquid crystal element of the corresponding pixel. The output interface 44 also outputs the doubled clock signals to each scan line and data line driving circuits.

In contrast to the prior art, the present invention discloses a novel driving method that applies an over-drive data voltage pulse and an original data voltage pulse to each pixel in one frame period so that the transmission rate of the liquid crystal molecules can be rapidly changed. Since at least one over-drive data voltage pulse and a original data voltage pulse are applied to each pixel in one frame period, the twisting speed of the liquid crystal molecule can be accelerated and the gray level switching can be accomplished in one frame period without delay, blur, reality loss, or brightness reduction. In addition, the present driving method uses a double frequency way to output the over-drive data voltage pulse and the original data voltage pulse, and the over-drive function is similar to that of the prior art, so the conventional over-drive engine can be also used in the present invention to reduce the cost.

Those skilled in the art will readily observe that numerous modifications and alterations of the method may be made while retaining the teachings of the invention. Accordingly, the above disclosure should be construed as limited only by the metes and bounds of the appended claims.

1. A method for driving a liquid crystal display panel, the liquid crystal display panel comprising:
a plurality of scan lines;
a plurality of data lines; and
a plurality of pixels, each pixel has a switching device and a liquid crystal element, and the switching device is connected to the corresponding scan line, the corresponding data line and the liquid crystal element;
the method comprising:
continuously receiving a plurality of frame data;
producing an over-drive data voltage pulse and an original data voltage pulse according to the frame data in every frame period; and
sequentially providing the over-drive data voltage pulse and the original data voltage pulse to the liquid crystal element of the pixel in one frame period via the connected data line.

2. The method of claim 1 further comprising:
delaying the frame data to produce a plurality of corresponding delayed frame data; and
deciding a value of the over-drive data voltage pulse by comparing a present frame data with the corresponding delayed frame data.

3. The method of claim 2, wherein when comparing the present frame data with the corresponding delayed frame data, the value of the over-drive data voltage pulse is decided according to a predetermined table.

4. The method of claim 1, wherein each frame data comprises a plurality of pixel data and each pixel data corresponds to one pixel.

5. The method of claim 1 further comprising:
providing a scan voltage to the switching device via the corresponding scan line to enable the over-drive data voltage pulse and the original data voltage pulse to be supplied to the liquid crystal element.

6. A method for driving a liquid crystal display panel, the liquid crystal display panel comprising:
a plurality of scan lines;
a plurality of data lines; and
a plurality of pixels, each pixel includes a switching device and a liquid crystal element, the switching device is connected to the corresponding scan line, the corresponding data line and the liquid crystal element;
the method comprising:
receiving a clock signal, a synchronization signal, and a plurality of frame data;
producing a double-frequency clock signal in accordance with the clock signal, and producing a double-frequency synchronization signal in accordance with the double-frequency clock signal and the synchronization signal;
producing at least an over-drive data voltage pulse and an original data voltage pulse in accordance with the frame data; and
sequentially providing the over-drive data voltage pulse and the original data voltage pulse to the liquid crystal element of the corresponding pixel in accordance with the double-frequency clock signal in one frame period.

7. The method of claim 6 further comprising:
delaying the frame data to produce a plurality of corresponding delayed frame data; and
deciding a value of the over-drive data voltage pulse by comparing a present frame data with the corresponding delayed frame data.

8. The method of claim 7, wherein when comparing the present frame data with the corresponding delayed frame data, the value of the over-drive data voltage pulse is decided according to a predetermined table.

9. The method of claim 6, wherein the synchronization signal includes a horizontal synchronization signal and a vertical synchronization signal.

10. The method of claim 6, wherein the double-frequency synchronization signal includes a horizontal double-frequency synchronization signal and a vertical double-frequency synchronization signal.

11. The method of claim 6, wherein each frame data comprises a plurality of pixel data and each pixel data corresponds to one pixel.

12. The method of claim 6 further comprising:
providing a scan voltage to the switching device via the corresponding scan line to enable the over-drive data voltage pulse and the original data voltage pulse supplied to the liquid crystal element.
